(19) United States
(12) Patent Application Publication
(10) Pub. No.: US 2015/0194724 A1
(43) Pub. Date: Jul. 9, 2015

(54) MILLIMETER WAVE ANTENNA STRUCTURES WITH AIR-GAP LAYER OR CAVITY

(71) Applicant: INTEL CORPORATION, Santa Clara, CA (US)

(72) Inventors: Ana Yepes, Hillsboro, OR (US); Helen Kankan Pan, Portland, OR (US); Mohamed A. Megahed, Gilbert, AZ (US); Bryce Horine, Aloha, OR (US); Eran Gerson, Pardes Hana (IL); Raana Sover, Haifa (IL)

(21) Appl. No.: 14/124,207

(22) PCT Filed: Aug. 16, 2013
(86) PCT No.: PCT/US2013/055392

§ 371 Date: Dec. 5, 2013

(51) Int. Cl. H01Q 1/24; H01Q 1/48; H01Q 9/04

(52) U.S. Cl. CPC H01Q 1/241; H01Q 9/045; H01Q 1/48

(57) ABSTRACT

Embodiments of millimeter-wave antenna structures are generally described herein. The antenna structure may include an a radiating-element layer comprising a patterned conductive material, a ground layer comprising conductive material disposed on a dielectric substrate, and a feed-line layer comprising conductive material disposed on a dielectric substrate. In some embodiments, the antenna structure may include an air-gap layer disposed between the radiating-element layer and the ground layer. The air-gap layer may include spacing elements to separate the radiating-element layer and the ground layer by a predetermined distance. In some other embodiments, the radiating-element layer may be disposed on a radiating-element dielectric substrate which may include one or more cavities between the radiating-element layer and the ground layer.

### TECHNICAL FIELD

Embodiments pertain to antennas and antenna structures. Some embodiments pertain to antennas and antenna structures for millimeter-wave communications. Some embodiments pertain to wireless communication devices (e.g., mobile devices and docking stations) that use antennas and antenna structures for communication of wireless signals. Some embodiments relate to devices that operate in accordance with the Wireless Gigabit Alliance (WiGig) (e.g., IEEE 802.11ad) protocol.

### BACKGROUND

Antenna size and antenna performance are some of the more challenging issues with wireless communications, particularly wireless communications at millimeter-wave wavelengths. High-speed wireless data communication protocols such as the WiGig protocol utilize a very broad bandwidth (e.g., up to 8 GHz). This poses a challenge on antenna designers who are already managing to meet other requirements such as compact form factor, high directivity, adaptive beam steering, low cost, etc. Some of these requirements make it difficult for an antenna to achieve a broad impedance bandwidth (i.e., the insertion loss bandwidth). For planar antennas printed on a thin dielectric substrate (h<<wavelength) of an arbitrary shape, the bandwidth may be directly proportional to the thickness of the substrate (h) and inversely proportional to the dielectric constant (∈ᵣ). A thicker substrate, however, may result in an increase in overall antenna volume and may also mean more complicated and costly fabrication. This makes achieving a broad impedance bandwidth, while at the same time meeting other antenna performance, size and manufacturing goals, a significant challenge.

Thus there are general needs for antennas and antenna structures that can achieve a broad impedance bandwidth while meeting other performance, size and manufacturing goals. There are also general needs for millimeter-wave antenna structures that can achieve a broad impedance bandwidth and may be suitable for communications in accordance with the WiGig protocol. There are also general needs for wireless communication devices that can communicate with improved performance at millimeter-wave frequencies.

### BRIEF DESCRIPTION OF THE DRAWINGS

FIG. 1 illustrates an example stack-up of the layers of an antenna structure in accordance with some embodiments;

FIGS. 2A-E illustrate side views of some of the layers of the antenna structure of FIG. 1 in accordance with some embodiments;

FIG. 3 illustrates a side view of some of the layers of the antenna structure of FIG. 1 in which the radiating-element layer is printed on a non-conductive chassis in accordance with some embodiments;

FIG. 4A illustrates a side view of some of the layers of an antenna structure that includes a single cavity in accordance with some embodiments;

FIG. 4B illustrates a top/bottom view of the cavity of the antenna structure of FIG. 4A in accordance with some embodiments;

FIG. 5A illustrates a side view of some of the layers of an antenna structure that includes a plurality of cavities in accordance with some embodiments;

FIG. 5B illustrates a top/bottom view of the cavities of the antenna structure of FIG. 5A in accordance with some embodiments;

FIG. 6 illustrates three views of a radiating-element dielectric substrate with thru-holes in accordance with some embodiments;

FIG. 7A illustrates patterned conductive material of the radiating-element layer in accordance with some embodiments; and

FIG. 7B illustrates conductive material of the ground layer in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

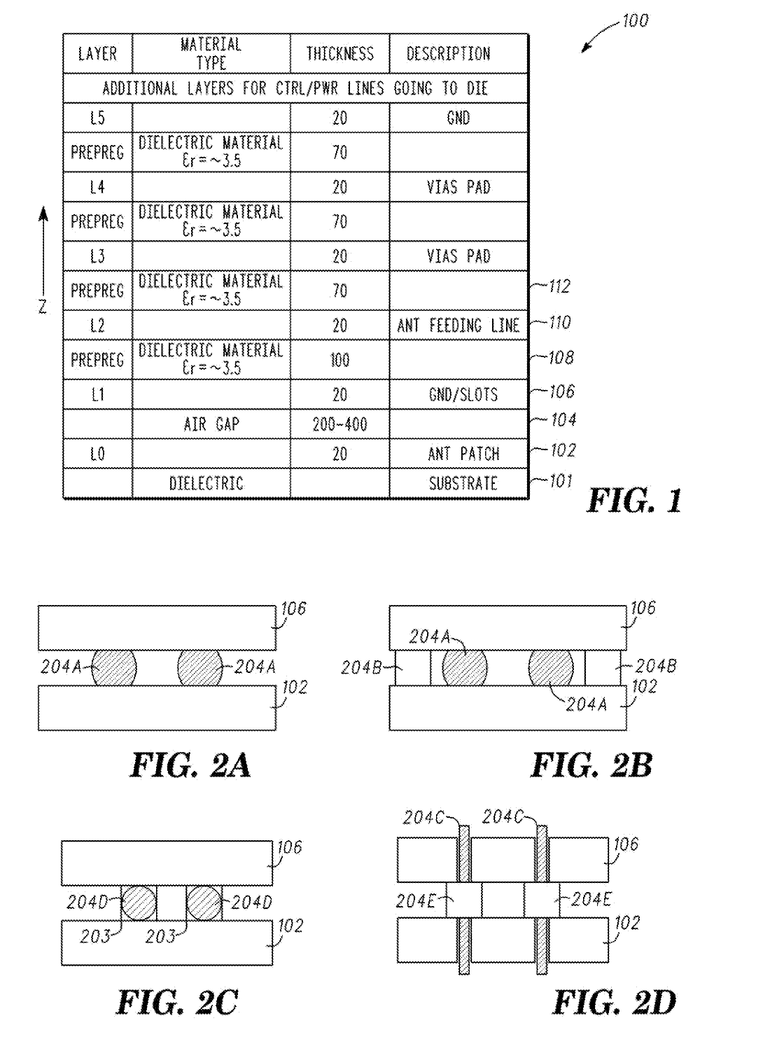

FIG. 1 illustrates an example stack-up of the layers of an antenna structure 100 in accordance with some embodiments. Antenna structure 100 may include a radiating-element layer 102 comprising a patterned conductive material, a ground layer 106 comprising conductive material disposed on a dielectric substrate 108, and a feed-line layer 110 comprising conductive material disposed on a dielectric substrate 112. The antenna structure 100 may also include an air-gap layer 104 disposed between the radiating-element layer 102 and the ground layer 106. In these embodiments, the air-gap layer 104 may include a plurality of spacing elements to separate the radiating-element layer 102 and the ground layer 106 by a predetermined distance to provide a gap. In some embodiments described in more detail below, the air-gap layer 104 may comprise one or more cavities. As illustrated, the feed-line layer 110 may be disposed adjacent to the ground layer 106 opposite the air-gap layer 104.

The use of the air-gap layer 104 to separate the radiating-element layer 102 and the ground layer 106 may help increase the impedance bandwidth of the antenna structure 100. The use of air-gap layer 104 may also help minimize the permittivity (∈r*∈0) which helps minimize the thickness of the antenna structure 100 (i.e., in the z-direction). In some example embodiments, up to an 8 GHz impedance bandwidth at some millimeter-wave frequencies (e.g., 57.4 GHz to 65.7 GHz) may be achieved, although the scope of the embodiments is not limited in this respect.

Although air-gap layer 104 is referred to as an ‘air-gap’ layer, the scope of the embodiments is not limited in this respect. In some embodiments, the gap may be filled with any substance (gas, liquid or solid) to help reduce or minimize the permittivity and increase the impedance bandwidth of the antenna structure 100. In these embodiments, a dielectric constant of one or close to one is desirable. Substances that may be suitable for use in the gap may include air and other gases including inert gases, as well as non-conductive low permittivity materials. In some embodiments, a vacuum may be provided in the gap.

In some embodiments, the separation between the radiating-element layer 102 and the ground layer 106 may range from a little as 200 um (microns) to as great as 600 um or more depending on the operating frequency. In some embodiments, the separation between the radiating-element layer 102 and the ground layer 106 may be less than 0.08 wavelengths of a millimeter-wave operating frequency (e.g., about 400 um at 60 GHz). In some embodiments, the separation may be as great as 1 millimeter or more depending on the operating frequency.

In some embodiments, the ground layer 106 may comprise conductive material disposed on a ground-layer dielectric substrate 108. The feed-line layer 110 may comprise conductive material disposed on a feed-line dielectric substrate 112.

In some WiGig embodiments, the radiating-element layer 102, the ground layer 106, the feed-line layer 110, and the air-gap layer 104 (as well as other layers) may be arranged to operate as an antenna for communication of millimeter-wave signals. The separation between the radiating-element layer 102 and the ground layer 106 may be less than 0.08 wavelengths. In these embodiments, the antenna structure 100 may be used for communication at millimeter-wave frequencies within one or more of the WiGig channels. Millimeter-wave frequencies may include operating frequencies ranging from 30 GHz to up to 300 GHz.

In some embodiments, the patterned conductive material of the radiating-element layer 102 may be disposed on a radiating-element dielectric substrate 101 opposite the air-gap layer 104. In these embodiments, no substrate is provided at the location of the air-gap layer 104 and a suitable dielectric material may be used to position the conductive material of the radiating-element layer 102. The dielectric substrate 101 may be a thin dielectric substrate (e.g., as thin as 60 um if metal is provided on both sides of the substrate and as thin as 200 um-400 um if metal is provided on one side of the substrate).

In some embodiments illustrated in FIG. 1, the radiating-element layer 102 may be referred to as layer zero (L0), the ground layer 106 may be referred to as layer one (L1) and the feed-line layer 110 may be referred to as layer two (L2). The antenna structure 100 may also include other layers including other dielectric substrates as illustrated in FIG. 1.

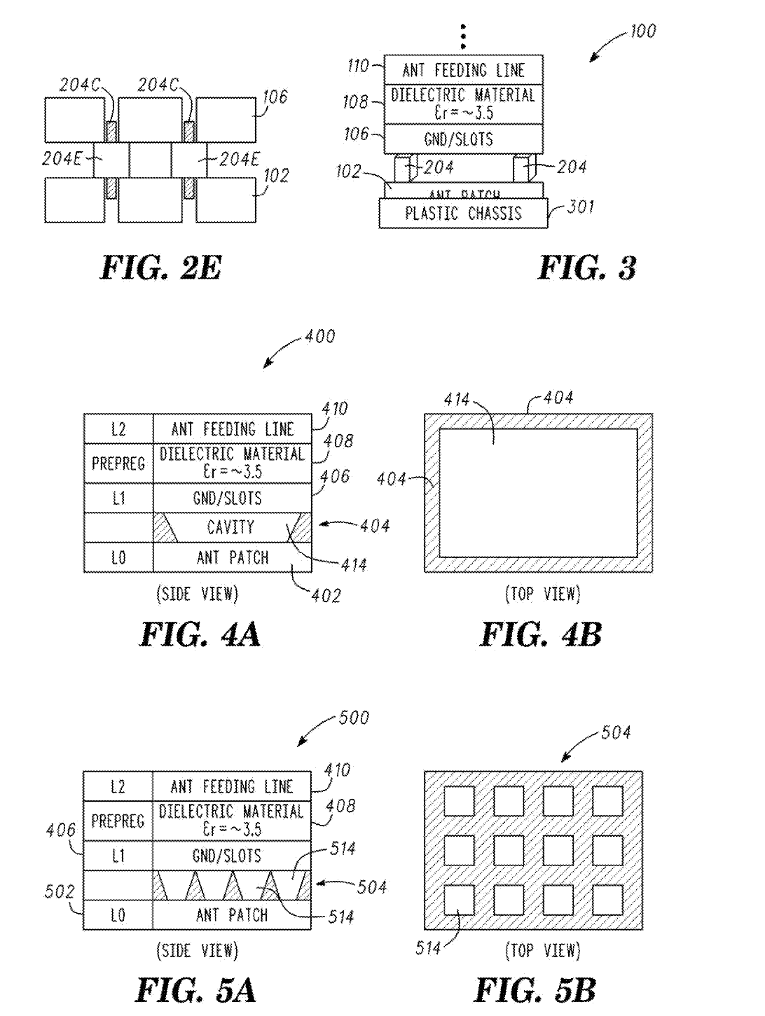

FIGS. 2A-E illustrate side views of some of the layers of the antenna structure of FIG. 1 using different types of spacing elements in accordance with some embodiments. As illustrated in FIG. 2A, the spacing elements used to separate the radiating-element layer 102 and the ground layer 106 by a predetermined distance may comprise solder balls 204A. In some of these embodiments, the solder balls 204A may be part of a ball-grid array (BGA). The solder balls 204A may be provided to separate the radiating-element layer 102 and the ground layer 106 by a predetermined distance to provide a gap. The solder balls 204A may also be used to help align the radiating-element layer 102 with the ground layer 106. This is described in more detail below. In some embodiments, some further characterization of the antenna structure 100 may be performed to adjust the height of the solder balls 204A after reflow to provide a predetermined distance between the radiating-element layer 102 with the ground layer 106.

In some embodiments, the spacing elements may also include spacers 204B (see FIG. 2B). In these embodiments, the spacers 204B may be used in addition to solder balls 204A. In these BGA embodiments, the spacers 204B may help control the gap during BGA reflow attach operations. In these embodiments, the finished BGA height may be close to that of the spacers 204B to provide the predetermined distance between the radiating-element layer 102 and the ground layer 106. In some alternate embodiments, spacers 204B without solder balls 204A may be used to separate the radiating-element layer 102 and the ground layer 106.

In some of these embodiments, the solder balls 204A may have a melting point temperature that is greater than the reflow temperature of the solder used to attach the solder balls 204A to the boards (e.g., the radiating-element layer 102 with the ground layer 106). In these embodiments, the solder balls may hold their shape during reflow to help maintain the gap height (i.e., the predetermined distance between the radiating-element layer 102 with the ground layer 106). An example of these embodiments is illustrated in FIG. 2C in which solder 203 may be used to attach the solder balls 204D to the boards.

In some other embodiments, the spacing elements to separate the radiating-element layer 102 and the ground layer 106 may comprise connectors 204C (see FIGS. 2D and 2E). The connectors 204C may be arranged to align the radiating-element layer 102 and the ground layer 106. In these embodiments, the connectors 204C may be used with spacers 204E to separate the radiating-element layer 102 and the ground layer 106 by the predetermined distance to provide a gap. The use of connectors 204C may allow the radiating-element layer 102 and the ground layer 106 to self-align during assembly.

In some embodiments, the connectors 204C may extend through the boards (see FIG. 2D), while in other embodiments, the connectors 204C may extend only part way through the boards (see FIG. 2E). In some embodiments, the connectors 204C may comprise pins. The pins may be stake pins although this is not a requirement. In some alternate embodiments, the pins may be soldered into a plated hole (not separately illustrated). In some other embodiments, the pins may be placed on a plated or non-plated thru-hole (i.e., not soldered) and the radiating-element layer 102 and the ground layer 106 may be held together by other means (e.g., solder balls, adhesive, etc.).

In some embodiments, the connectors 204C may comprise a snap-fit or rivet-like device. In some embodiments, the connectors 204C may have a controlled standoff height to provide the predetermined distance to separate the radiating-element layer 102 and the ground layer 106.

FIG. 3 illustrates a side view of some of the layers of the antenna structure of FIG. 1 in which the radiating-element layer is printed on a non-conductive chassis 301 in accordance with some embodiments. In these embodiments, the patterned conductive material of the radiating-element layer 102 may be printed on or disposed on a non-conductive chassis 301. The non-conductive chassis 301 may be a docking station chassis or a chassis of any mobile platform and would serve as a dielectric substrate for the conductive material of the radiating-element layer 102, although the scope of the embodiments is not limited in this respect.

FIG. 4A illustrates a side view of some of the layers of an antenna structure 400 that includes a single cavity in accordance with some embodiments. FIG. 4B illustrates a top/bottom view of the cavity of the antenna structure 400 of FIG. 4A, in accordance with some embodiments.

FIG. 5A illustrates a side view of some of the layers of an antenna structure 500 that includes a plurality of cavity in accordance with some embodiments. FIG. 5B illustrates a top/bottom view of the cavities of the antenna structure 500 of FIG. 5A, in accordance with some embodiments.

In the embodiments illustrated in FIGS. 4A and 4B and FIGS. 5A and 5B, the antenna structures 400/500 may comprise a radiating-element layer 402/502 comprising patterned conductive material disposed on a radiating-element dielectric substrate 404/504, a ground layer 406 comprising conductive material, and a feed-line layer 410 comprising conductive material. In these embodiments, the radiating-element dielectric substrate 404 may include one or more cavities 414/514 between the radiating-element layer 402 and the ground layer 406. Accordingly, a gap may be provided between the radiating-element layer 402/502 and the ground layer 406. In these embodiments, the feed-line layer 410 is disposed adjacent to the ground layer 406 opposite the radiating-element dielectric substrate 404.

In these embodiments, the one or more cavities 414/514 between the radiating-element layer 402/502 and the ground layer 406 may help increase the impedance bandwidth of the antenna structure 400/500. The use of one or more cavities 414/514 within the radiating-element dielectric substrate 404/504 may help minimize the permittivity which helps minimize the thickness of the antenna (in the z-direction). The use of one or more cavities 414/514 in a non-conductive substrate 404/504 may effectively provide a gap between the radiating-element layer 402 and the ground layer 406. The cavities 414/514 may be filled with air or may be filled with almost any substance as discussed above to help minimize the permittivity.

In these embodiments, the ground layer 406 may comprise conductive material disposed on a ground-layer dielectric substrate 408. The feed-line layer 410 may comprise conductive material disposed on a feed-line dielectric substrate.

In single-cavity embodiments, the patterned conductive material of the radiating-element layer 402 (FIG. 4A) may comprise a single patch associated with the single cavity 414. In some single-cavity embodiments, the dielectric substrate 404 (see FIG. 4B) may be arranged to provide a single larger cavity 414 between the radiating-element layer 402 and the ground layer 406. Although FIG. 4B illustrates a single large cavity 414, the cavity 414 may include structural elements, such as spacers.

In multi-cavity embodiments, the patterned conductive material of the radiating-element layer 502 (FIG. 5A) may comprise a plurality of patches as described above, each patch may be associated with one cavity 514. In these multi-cavity embodiments, each cavity may be associated with a single patch (e.g., metal for a patch would reside on top of or be provided over every cavity).

In some multi-cavity embodiments, the dielectric substrate 504 (see FIG. 5B) may be arranged to provide a plurality of smaller cavities 514 between the radiating-element layer 502 and the ground layer 406. Although FIG. 5B illustrates a plurality of equally sized square-shaped cavities within the radiating-element dielectric substrate 504, this is not a requirement. In some embodiments, the cavities 514 may be have other sized and/or may be differently sized.

In some embodiments, the radiating-element layer 402/502 (FIG. 4A or FIG. 5A) may also comprise plurality of thru-holes. In these embodiments, small holes in the radiating-element layer 402/502 (i.e., L0) may allow any hot air that may be trapped during manufacturing to be released. In some embodiments, small holes may be provided in the radiating-element layer 402/502 when the radiating-element dielectric substrate 404/504 comprises one or more cavities 414/514 (e.g., for release of hot air).

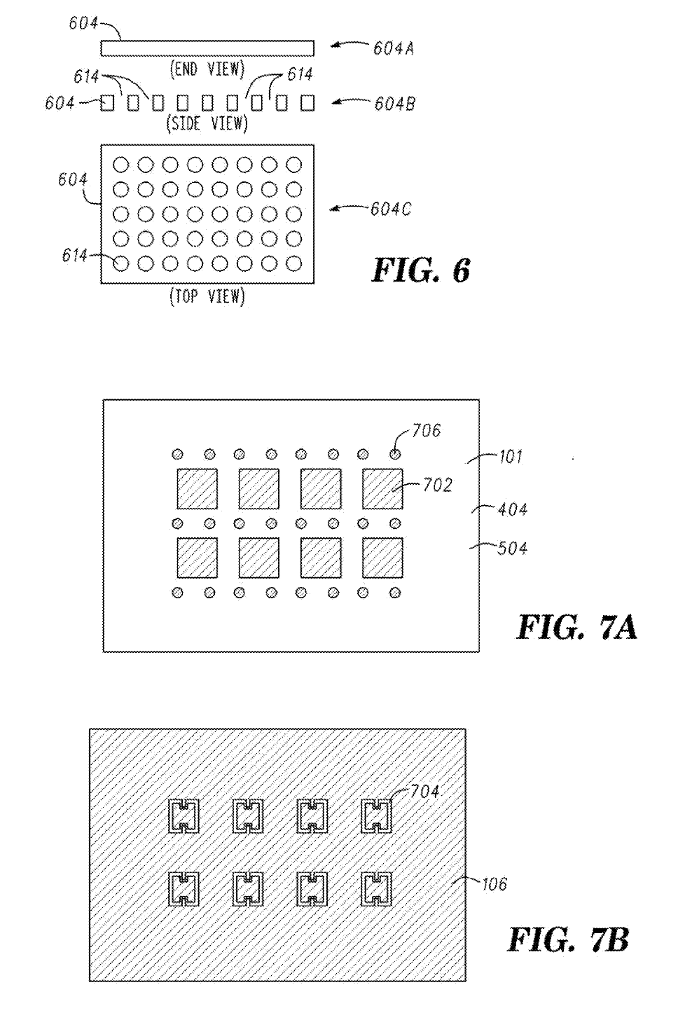

FIG. 6 illustrates three views of a radiating-element dielectric substrate 604 with thru-holes in accordance with some other embodiments. In these embodiments, the radiating-element dielectric substrate 604 may have a plurality of thru-holes 614. In these embodiments, the radiating-element dielectric substrate 604 may be used in place of the dielectric substrate 404 (FIGS. 4A and 4B) of antenna structure 400 or may be used in place of the dielectric substrate 504 (FIGS. 5A and 5B) of antenna structure 500. The thru-holes 614 may help increase the impedance bandwidth of an antenna structure and help minimize the permittivity. This may help minimize the thickness of an antenna structure.

Reference number 604A illustrates an end view of radiating-element dielectric substrate 604 (i.e., from the end or edge), reference number 604B is a side view of radiating-element dielectric substrate 604 sectioned through the thru-holes 614, and reference number 604C illustrates a top view of radiating-element dielectric substrate 604.

In some embodiments in which the radiating-element dielectric substrate 604 includes thru-holes 614, the radiating-element layer (e.g., radiating-element layer 402/502 (FIG. 4A or FIG. 5A)) may also include a plurality of thru-holes.

FIG. 7A illustrates patterned conductive material of the radiating-element layer in accordance with some embodiments. FIG. 7B illustrates conductive material of the ground layer 106 in accordance with some embodiments of FIG. 7A. In these embodiments, the patterned conductive material of the radiating-element layer may comprise a plurality of patches 702 (FIG. 7A) and the conductive material of the ground layer 106 may comprise a plurality of slots 704 (FIG. 7B). Each slot 704 may be devoid of conductive material may be aligned with one of the patches 702 to provide a patch/slot set. In these embodiments, the feed-line layer 110/410 (FIG. 1 or FIG. 4A/FIG. 5A) may comprise one or more feed lines to couple with the plurality of patches 702 through one or more of the slots 704 in the ground layer 106 to provide an aperture-coupled antenna configuration.

In some embodiments, each patch/slot set may have a single feed line. In these embodiments, the slots 704 may operate as apertures allowing the feed lines to couple signals to and from the patches 702. In some of these embodiments, the feed lines of the feed-line layer 110/410 may comprise microstrip feed lines to provide an aperture-coupled microstrip antenna configuration. In some phased-array embodiments, the phase excitation of each element or patch 702 may be controlled to provide an aperture-coupled microstrip phased-array antenna configuration. In these embodiments, a microstrip feed line may couple to a patch 702 through an aperture (e.g., slot 704) in the ground plane (i.e., ground layer 106 of FIG. 1 or ground layer 406 FIGS. 4A and 5A). In some of these embodiments, each patch 702 by itself may operate as a single antenna or a single element of an array antenna.

In embodiments, the patches 702 may be square, circular, or rectangular or may have another shape based on desired antenna characteristics. In some embodiments, rather than patches 702, other conductive material patterns may be used. Slots 704 may be square, circular or bowtie-shaped, or may have another shape based on the desired antenna characteristics. In some embodiments, the conductive material of the radiating-element layer and the slots may be arranged to provide a single feed circularly polarized phased array antenna. A broadband antenna may also be provided.

In some embodiments, the antenna structures described herein may be arranged to provide one or more directional or omnidirectional antennas, including, for example, dipole antennas, monopole antennas, patch antennas, loop antennas, microstrip antennas or other types of antennas suitable for transmission of RF or millimeter-wave signals. In some aperture-coupled embodiments, each aperture may be considered a separate antenna. In some multiple-input multiple-output (MIMO) embodiments, the antenna structure may be configured to take advantage of spatial diversity and the different channel characteristics in a MIMO channel.

In some embodiments, when solder balls 204A are used as the spacing elements, the patterned conductive material of the radiating-element layer may include a plurality of solder-ball pads 706 that are electrically isolated from the patches 702. Each of the pads 706 may be used for attachment of one of the solder balls 204A to the radiating-element dielectric layer (either layer 101 (FIG. 1) or the non-conductive chassis 301 (FIG. 3).

In some embodiments, the solder balls 204A, functioning as spacing elements, may provide a mechanical connection (but not an electrical connection) between the ground layer 106 and the radiating-element layer (FIG. 7A). In these embodiments, the spacing elements may be evenly distributed to provide vertical alignment between the slots 704 and the patches 702 such that each slot 704 is centered below a corresponding patch 702. Other alignment techniques previously described may also be suitable for the alignment of these layers.

In some embodiments, a wireless communication device may be provided. The wireless communication device may be, for example, a mobile device or a docking station, although the scope of these embodiments is not limited in this respect. In these embodiments, the wireless communication device may include a millimeter-wave transceiver and an antenna structure coupled to the millimeter-wave transceiver. The antenna may be arranged for communicating the millimeter-wave signals with another device. Any of the embodiments of the antenna structures described above may be suitable for use in the wireless communication device. In some embodiments, the millimeter-wave transceiver may be part of a WiGig module, although this is not a requirement.

In some embodiments, the wireless communication device may be personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the wireless communication device may include one or more of a keyboard, a display, a non-volatile memory port, multiple antennas, a graphics processor, an application processor, speakers, and other mobile device elements. The display may be a liquid-crystal display (LCD) screen including a touch screen.

In these embodiments, when the wireless communication device is a docking station, the antenna structure may be configured as an aperture-coupled antenna for communicating circularly-polarized signals with a mobile device that communicates signals having one of vertical, horizontal or slanted polarizations. In these embodiments, since the antenna structure of the docking station may be arranged to communicate circularly-polarized signals, the docking station may be able to communicate with mobile devices that communicate signals of various polarizations. In some of these embodiments, the antenna of the docking station may be a highly-directional phased-array antenna.

In some embodiments in which the wireless communication device is a mobile device (e.g., a smart phone or other portable device), the antenna structure may provide an antenna for communicating signals having one of vertical, horizontal or slanted polarizations, although this is not a requirement. In some of these embodiments, the mobile device may be arranged to communicate with the docking station in accordance with a WiGig protocol.

In an example embodiment, an antenna structure comprises: a radiating-element layer comprising a patterned conductive material; a ground layer comprising conductive material disposed on a dielectric substrate; a feed-line layer comprising conductive material disposed on a dielectric substrate; and an air-gap layer disposed between the radiating-element layer and the ground layer, wherein the air-gap layer comprises a plurality of spacing elements to separate the radiating-element layer and the ground layer by a predetermined distance, and wherein the feed-line layer is disposed adjacent to the ground layer opposite the air-gap layer. In an example embodiment, the radiating-element layer, the ground layer, the feed-line layer, and the air-gap layer are arranged to operate as an antenna for communication of millimeter-wave signals, and wherein the spacing elements are arranged to separate the radiating-element layer and the ground layer by less than 0.08 wavelengths of a millimeter-wave operating frequency. In an example embodiment, the spacing elements comprise solder balls. In an example embodiment, the spacing elements further include spacers. In an example embodiment, the spacing elements comprise connectors, the connectors arranged to align the radiating-element layer and the ground layer and include a spacer arranged to separate the radiating-element layer and the ground layer by the predetermined distance. In an example embodiment, the connectors comprise pins. In an example embodiment, the patterned conductive material of the radiating-element layer is disposed on a dielectric substrate opposite the air-gap layer. In an example embodiment, the patterned conductive material of the radiating-element layer is printed on a non-conductive chassis. In an example embodiment, the patterned conductive material of the radiating-element layer comprises a plurality of patches, wherein the conductive material of the ground layer comprises a plurality of slots, each slot aligned with one of the patches, and wherein the feed-line layer comprises one or more feed lines to couple with the plurality of patches through one or more of the slots in the ground layer to provide an aperture-coupled antenna configuration. In an example embodiment, the when solder balls are used as the spacing elements, the patterned conductive material of the radiating-element layer comprises a plurality of solder-ball pads that are electrically isolated from the patches, and each of the pads may be used for attachment of one of the solder balls to the radiating-element dielectric layer.

In other example embodiments, the antenna structure comprises: a radiating-element layer comprising patterned conductive material disposed on a radiating-element dielectric substrate; a ground layer comprising conductive material; and a feed-line layer comprising conductive material, wherein the radiating-element dielectric substrate comprises one or more cavities between the radiating-element layer and the ground layer, and wherein the feed-line layer is disposed adjacent to the ground layer opposite the radiating-element dielectric substrate. In an example embodiment, the radiating-element dielectric substrate is arranged to provide a single cavity between the radiating-element layer and the ground layer. In an example embodiment, the radiating-element dielectric substrate is arranged to provide a plurality of cavities between the radiating-element layer and the ground layer. In an example embodiment, the radiating-element dielectric substrate comprises a plurality of thru-holes. In an example embodiment, the radiating-element layer further comprises a plurality of thru-holes.

In other example embodiment, a wireless communication device comprises; a millimeter-wave transceiver; and an antenna structure as described herein coupled to the millimeter-wave transceiver, the antenna arranged for communicating millimeter-wave signals with another device. In an example embodiment, the wireless communication device comprises a docking station, and wherein the antenna structure is configured as an aperture-coupled antenna for communicating circularly-polarized signals with a mobile device that communicates signals having one of vertical, horizontal or slanted polarizations. In an example embodiment, the wireless communication device comprises a mobile device, and wherein the antenna structure provides an antenna for communicating signals having one of vertical, horizontal or slanted polarizations.

In another example embodiment, an aperture-coupled antenna comprises: a radiating-element layer comprising a plurality of patches arranged for communication of millimeter-wave signals; a ground layer comprising conductive material disposed on a dielectric substrate and comprising a plurality of slots, each slot aligned with one of the patches of the radiating-element layer; a feed-line layer comprising conductive material disposed on a dielectric substrate and comprising a plurality of feed lines, each to couple signals with one of the patches through one of the slots in the ground layer; and an air-gap layer disposed between the radiating-element layer and the ground layer to separate the radiating-element layer and the ground layer by less than 0.08 wavelengths of a millimeter-wave operating frequency, wherein the feed-line layer is disposed adjacent to the ground layer opposite the air-gap layer. In an example embodiment, the air-gap layer comprises a plurality of spacing elements to separate the radiating-element layer and the ground layer by a predetermined distance, the spacing elements comprising at least one of solder balls and connectors. In an example embodiment, the air-gap layer comprises a dielectric substrate having one or more cavities between the radiating-element layer and the ground layer.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An antenna structure comprising:
a radiating-element layer comprising a patterned conductive material;
a ground layer comprising conductive material disposed on a dielectric substrate;
a feed-line layer comprising conductive material disposed on a dielectric substrate; and
an air-gap layer disposed between the radiating-element layer and the ground layer,
wherein the air-gap layer comprises a plurality of spacing elements to separate the radiating-element layer and the ground layer by a predetermined distance, and
wherein the feed-line layer is disposed adjacent to the ground layer opposite the air-gap layer.

2. The antenna structure of claim 1 wherein the radiating-element layer, the ground layer, the feed-line layer, and the air-gap layer are arranged to operate as an antenna for communication of millimeter-wave signals, and
wherein the spacing elements are arranged to separate the radiating-element layer and the ground layer by less than 0.08 wavelengths of a millimeter-wave operating frequency.

3. The antenna structure of claim 2 wherein the spacing elements comprise solder balls.

4. The antenna structure of claim 3 wherein the spacing elements further include spacers.

5. The antenna structure of claim 2 wherein the spacing elements comprise connectors, the connectors arranged to align the radiating-element layer and the ground layer and include a spacer arranged to separate the radiating-element layer and the ground layer by the predetermined distance.

6. The antenna structure of claim 5 wherein the connectors comprise pins.

7. The antenna structure of claim 2 wherein the patterned conductive material of the radiating-element layer is disposed on a dielectric substrate opposite the air-gap layer.

8. The antenna structure of claim 2 wherein the patterned conductive material of the radiating-element layer is printed on a non-conductive chassis.

9. The antenna structure of claim 2 wherein the patterned conductive material of the radiating-element layer comprises a plurality of patches,
wherein the conductive material of the ground layer comprises a plurality of slots, each slot aligned with one of the patches, and
wherein the feed-line layer comprises one or more feed lines to couple with the plurality of patches through one or more of the slots in the ground layer to provide an aperture-coupled antenna configuration.

10. The antenna structure of claim 3 wherein when solder balls are used as the spacing elements, the patterned conductive material of the radiating-element layer comprises a plurality of solder-ball pads that are electrically isolated from the patches, each of the pads may be used for attachment of one of the solder balls to the radiating-element dielectric layer.

11. An antenna structure comprising:
a radiating-element layer comprising patterned conductive material disposed on a radiating-element dielectric substrate;
a ground layer comprising conductive material; and
a feed-line layer comprising conductive material,
wherein the radiating-element dielectric substrate comprises one or more cavities between the radiating-element layer and the ground layer, and
wherein the feed-line layer is disposed adjacent to the ground layer opposite the radiating-element dielectric substrate.

12. The antenna structure of claim 11 wherein the radiating-element dielectric substrate is arranged to provide a single cavity between the radiating-element layer and the ground layer.

13. The antenna structure of claim 11 wherein the radiating-element dielectric substrate is arranged to provide a plurality of cavities between the radiating-element layer and the ground layer.

14. The antenna structure of claim 11 wherein the radiating-element dielectric substrate comprises a plurality of thru-holes.

15. The antenna structure of claim 14 wherein the radiating-element layer further comprises a plurality of thru-holes.

16. A wireless communication device comprising;
a millimeter-wave transceiver; and
an antenna structure in accordance with any of claims 1-15 coupled to the millimeter-wave transceiver, the antenna arranged for communicating millimeter-wave signals with another device.

17. The wireless communication device of claim 16, wherein the wireless communication device comprises a docking station, and
wherein the antenna structure is configured as an aperture-coupled antenna for communicating circularly-polarized signals with a mobile device that communicates signals having one of vertical, horizontal or slanted polarizations.

18. The wireless communication device of claim 16, wherein the wireless communication device comprises a mobile device, and
wherein the antenna structure provides an antenna for communicating signals having one of vertical, horizontal or slanted polarizations.

19. An aperture-coupled antenna comprising:
a radiating-element layer comprising a plurality of patches arranged for communication of millimeter-wave signals;
a ground layer comprising conductive material disposed on a dielectric substrate and comprising a plurality of slots, each slot aligned with one of the patches of the radiating-element layer;
a feed-line layer comprising conductive material disposed on a dielectric substrate and comprising a plurality of feed lines, each to couple signals with one of the patches through one of the slots in the ground layer; and
an air-gap layer disposed between the radiating-element layer and the ground layer to separate the radiating-element layer and the ground layer by less than 0.08 wavelengths of a millimeter-wave operating frequency,
wherein the feed-line layer is disposed adjacent to the ground layer opposite the air-gap layer.

20. The aperture-coupled antenna of claim 19 wherein the air-gap layer comprises a plurality of spacing elements to separate the radiating-element layer and the ground layer by a predetermined distance, the spacing elements comprising at least one of solder balls and connectors.

21. The aperture-coupled antenna of claim 19 wherein the air-gap layer comprises a dielectric substrate having one or more cavities between the radiating-element layer and the ground layer.
